(19) United States
(12) Patent Application Publication
(10) Pub. No.: US 2010/0231690 A1
(43) Pub. Date: Sep. 16, 2010

(54) MODEL DISPLAY METHOD FOR THREE-DIMENSIONAL OPTICAL SENSOR AND THREE-DIMENSIONAL OPTICAL SENSOR

(75) Inventors: Shiro Fujieda, Otokuni-gun (JP); Atsushi Taneno, Kyoto-shi (JP); Hiroshi Yano, Osaka (JP); Yasuyuki Ikeda, Osaka (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 12/710,266

(22) Filed: Feb. 22, 2010

(30) Foreign Application Priority Data
Mar. 12, 2009 (JP) 2009-059921

(51) Int. Cl. H04N 13/02; G06K 9/00

(52) U.S. Cl. 348/47; 382/154; 348/E13.074

(57) ABSTRACT

The degree of accuracy and the recognition result of a three-dimensional model can be easily, visually confirmed. After a three-dimensional model of a workpiece to be recognized is generated, this three-dimensional model is used to execute a recognition test on three-dimensional information of an actual model of the workpiece. Then, the three-dimensional model is subjected to coordinate transformation processing based on the recognized position and the rotational angle, and the three-dimensional coordinates of the converted three-dimensional model are subjected to the transparent transformation processing onto imaging planes of the cameras A, B, C that take images for the recognition processing. Then, the projected image of the three-dimensional model is displayed in overlaying manner by overlaying on the image of the actual model that is used in the recognition processing and is generated by the cameras A, B, C.

This application is based on Japanese Patent Application No. 2009-059921 filed with the Japan Patent Office on Mar. 12, 2009, the entire content of which is hereby incorporated by reference.

### BACKGROUND OF THE INVENTION

1. Technical Field

The present invention relates to a three-dimensional optical sensor that recognizes an object with three-dimensional measurement processing using a stereo camera.

2. Related Art

For example, when three-dimensional recognition processing is performed in order to cause a robot to grip a component in a manufacturing site, three-dimensional information reconstructed by three-dimensional measurement with a stereo camera is matched with a previously-registered three-dimensional model of the recognition-target object, so that the position and the attitude of the recognition-target object (more specifically, a rotational angle with respect to the three-dimensional model) is recognized (see Japanese Unexamined Patent Publication No. 2000-94374).

For this kind of recognition processing, there is suggested a method for generating a three-dimensional model representing the entire structure of the recognition-target object, wherein the method includes the steps of executing three-dimensional measurement of an actual model of the recognition-target object from a plurality of direction and positioning and synthesizing the three-dimensional information reconstructed in each of the directions (see Japanese Patent No. 2961264). However, the method for generating the three-dimensional model representing the entire structure is not limited to the use of an actual model. The three-dimensional model representing the entire structure may be generated from design information such as CAD data.

When recognition processing is performed using a three-dimensional model, it is preferable to test whether a real recognition-target object can be correctly recognized using the three-dimensional model registered in advance. However, even when coordinates and rotational angles representing the position of the recognition-target object are displayed based on matching with the three-dimensional model, it is difficult for the user to readily understand the specific contents represented by these numerical values.

A demand for a display allowing easy understanding of a recognition result and the degree of accuracy arises at the site in which it is necessary to display the recognition result upon this processing, for example, to display a recognition result in a three-dimensional model for the purpose of inspection.

### SUMMARY

In view of the above background circumstances, the present invention aims to improve the convenience of a three-dimensional optical sensor by presenting a display such that the user can easily find out whether or not a three-dimensional model to be registered is appropriate and the user can easily find out a result of a recognition processing using the registered three-dimensional model.

In accordance with one aspect of the present invention, a model display method is executed by a three-dimensional optical sensor. The three-dimensional optical sensor includes a plurality of cameras for generating a stereo image, a recognizing unit, and a registering unit, wherein the recognizing unit executes three-dimensional measurement using the stereo image generated by imaging a predetermined recognition-target object with each of the cameras, and matches three-dimensional information reproduced by the measurement with a three-dimensional model of the recognition-target object and recognizes a position and an attitude of the recognition-target object, and wherein the registering unit registers the three-dimensional model. The model display method is characterized by executing first to third steps as follows.

The first step includes performing coordinate conversion of the three-dimensional model that has been or has not yet been registered to the registering unit based on the position and the attitude that have been recognized by the recognizing unit, and performing transparent transformation of the coordinate-converted three-dimensional model into a coordinate system of at least one of the plurality of cameras to thereby generate a projected image of the three-dimensional model. The second step includes displaying, on a monitor apparatus, the projected image generated by the transparent transformation performed in the first step.

According to the above method, for example, the three-dimensional model to be registered is generated, and thereafter, the recognition processing of the actual model of the recognition-target object is executed with this three-dimensional model, so that the projected image of the three-dimensional model reflecting the position and the attitude according to the recognition result can be displayed. Further, this projected image is generated by the transparent transformation processing onto an imaging plane of the camera that takes the recognition-target object. Therefore, if the recognition result is correct, the three-dimensional model of the projected image is considered to have the same position and attitude as the recognition-target object in the image taken for recognition. Accordingly, the user can compare this projected image with the image used for the recognition processing, and can easily determine whether or not the generated three-dimensional model is appropriate for the recognition processing, thus determining whether the generated three-dimensional model should be registered.

Even when the recognition result is displayed in this processing performed with the registered three-dimensional model, the projected image can be displayed in the same manner as the above, so that the user can easily confirm the recognition result.

In accordance with a preferred aspect of the above method, the second step may be executed with respect to all of the plurality of cameras. In the second step, the projected image generated in the first step is displayed in overlaying manner by overlaying on the image that is generated by each of the cameras and used in the processing performed by the recognizing unit.

According to the above embodiment, the three-dimensional model images arranged in the positions and attitudes according to the respective recognition results of the cameras used in the three-dimensional recognition processing are displayed in overlaying manner by overlaying on the image of the real recognition-target object. Therefore, the user can find out the degree of accuracy in the recognition using the three-dimensional model from the difference in appearance and the degree of displacement between them.

In accordance with another aspect of the present invention, a three-dimensional optical sensor includes a plurality of cameras generating a stereo image, a recognizing unit, and a registering unit, wherein the recognizing unit executes three-dimensional measurement using the stereo image generated by imaging a predetermined recognition-target object with each of the cameras, and matches three-dimensional information reproduced by the measurement with a three-dimensional model of the recognition-target object and recognizes a position and an attitude of the recognition-target object, and wherein the registering unit registers the three-dimensional model.

The three-dimensional optical sensor includes a transparent transformation unit for performing coordinate conversion of the three-dimensional model that has been or has not yet been registered to the registering unit based on the position and a rotational angle that have been recognized by the recognizing unit, and performing transparent transformation of the coordinate-converted three-dimensional model into a coordinate system of at least one of the plurality of cameras to thereby generate a projected image of the three-dimensional model; and a display control unit for displaying, on a monitor apparatus, the projected image generated in the processing performed by the transparent transformation unit.

In accordance with a preferred aspect of the above three-dimensional optical sensor, the transparent transformation unit may execute the transparent transformation processing with respect to all of the plurality of cameras. The display control unit may display the projected image in overlaying manner by overlaying on the image that is generated by each of the cameras and used in the recognition processing performed by the recognizing unit.

According to the above three-dimensional optical sensor, the user can visually, easily confirm the accuracy of the three-dimensional model and the recognition result using the three-dimensional model. Therefore, the convenience of the three-dimensional optical sensor can be greatly enhanced.

### BRIEF DESCRIPTION OF THE DRAWINGS

FIG. 1 is a configuration of a production line where a three-dimensional optical sensor is introduced;

FIG. 2 is a block diagram showing an electrical configuration of the three-dimensional optical sensor;

FIG. 3 is a view showing a configuration example of a three-dimensional model;

FIG. 4 is a view showing a method for generating the three-dimensional model;

FIG. 5 is a flowchart showing a processing procedure of generation and registration of the three-dimensional model;

FIG. 6 is a view showing an example of a start screen of a recognition test; and

FIG. 7 is a view showing an example of a display screen showing a result of the recognition test.

### DETAILED DESCRIPTION

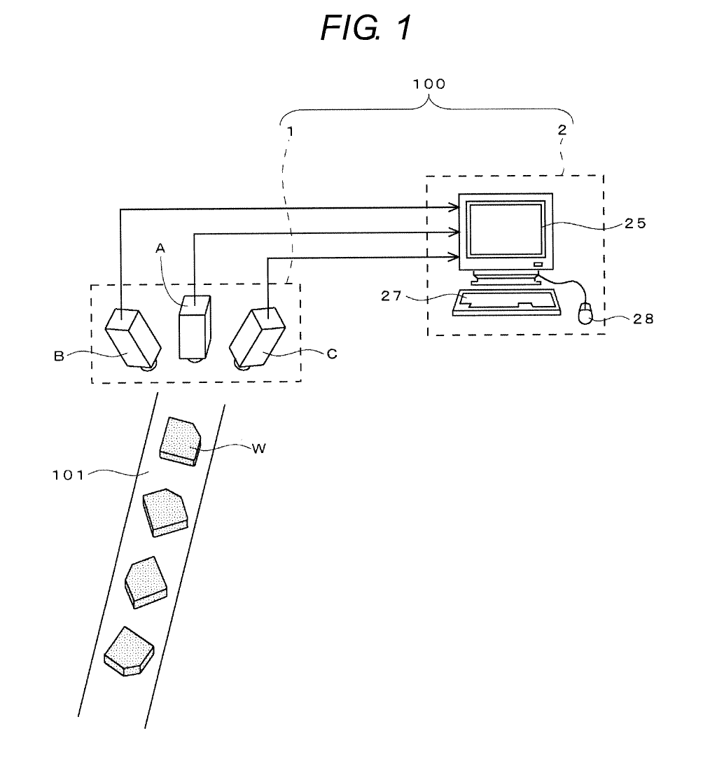

FIG. 1 shows an example of a three-dimensional optical sensor 100 that is introduced to a production line.

The three-dimensional optical sensor 100 according to this embodiment is used to recognize the position and attitude of a workpiece W (which is represented in a simplified form for the sake of making the description simpler) conveyed by a conveyance line 101 so as to be incorporated into a predetermined product. Information representing a recognition result is transmitted to a controller of a robot (both of which are not shown in the figures) arranged downstream of the line 101, and the information is used to control operation of the robot.

The three-dimensional optical sensor 100 includes a stereo camera 1 and a recognition processing apparatus 2 arranged in proximity to the line 101. The stereo camera 1 includes three cameras A, B, C arranged side by side above the conveyance line 101. Among these, the central camera A is arranged such that an optical axis is directed in the vertical direction (in other words, the camera A images the front surface of the workpiece W). The right and left cameras B and C are arranged such that the optical axes are diagonal.

The recognition processing apparatus 2 is a personal computer storing a dedicated program, and includes a monitor apparatus 25, a keyboard 27, and a mouse 28. This recognition processing apparatus 2 imports the images generated by the cameras A, B, C. After the recognition processing apparatus 2 executes three-dimensional measurement of the outline of the workpiece W, the recognition processing apparatus 2 matches the reconstructed three-dimensional information with the three-dimensional model registered in the apparatus in advance.

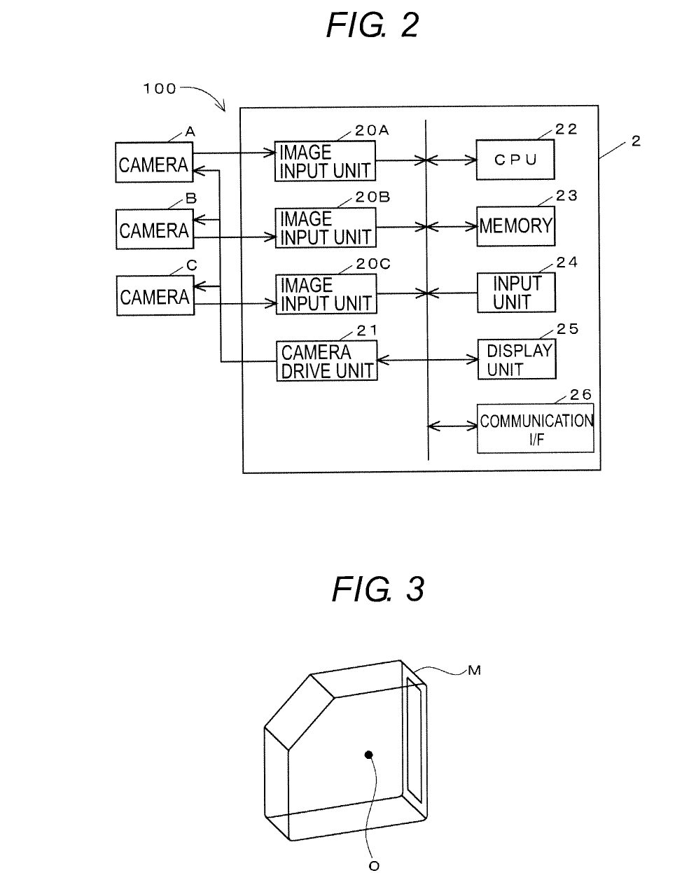

FIG. 2 is a block diagram showing a configuration of the above three-dimensional optical sensor 100. As shown in this figure, the recognition processing apparatus 2 includes image input units 20A, 20B, 20C corresponding to the cameras A, B, C, a camera drive unit 21, a CPU 22, a memory 23, an input unit 24, a display unit 25, a communication interface 26, and the like.

The camera drive unit 21 drives the cameras A, B, C at the same time according to an instruction given by the CPU 22. Therefore, the image generated by the cameras A, B, C is inputted to the CPU 22 via the image input units 20A, 20B, 20C.

The display unit 25 is a monitor device in FIG. 1. The input unit 24 is a combination of the keyboard 27 and the mouse 28 of FIG. 1. These are used in order to input information for setting and display information for supporting operation during calibration processing. The communication interface 26 is used to communicate with a host apparatus.

The memory 23 includes a large capacity memory such as a ROM, a RAM, and a hard disk. The memory 23 stores programs and setting data used for calibration processing, generation of a three-dimensional model, and three-dimensional recognition processing of the workpiece W. In addition, a dedicated area of the memory 23 stores parameters and three-dimensional models for three-dimensional measurement calculated by the calibration processing.

The CPU 22 executes the calibration processing and registration processing of a three-dimensional model based on the programs in the memory 23. As a result, the three-dimensional recognition processing can be performed on the workpiece W.

In the calibration processing, a world coordinate system is defined such that a distance from a surface supporting the workpiece W (namely, the upper surface of the conveyance line 101 of FIG. 1) is Z coordinate representing the height by using a calibration plate (not shown) on which a predetermined calibration pattern is drawn. Then, imaging of the calibration plate and image processing are executed for a plurality of cycles. A plurality of combinations of a three-dimensional coordinate (X, Y, Z) and a two-dimensional coordinate (x, y) are identified for each camera. These combinations of coordinates are used to derive a 3-by-4 transparent transformation matrix which is applied to the following transformation equation (equation (1))

$$S ( \begin{matrix}x \\ y \\ 1\end{matrix} ) = ( \begin{matrix}{P}_{00} & {P}_{01} & {P}_{02} & {P}_{03} \\ {P}_{10} & {P}_{11} & {P}_{12} & {P}_{13} \\ {P}_{20} & {P}_{21} & {P}_{22} & {P}_{23}\end{matrix} ) ( \begin{matrix}X \\ Y \\ Z \\ 1\end{matrix} ) \qquad ( 1 )$$

Elements P₀₀, P₀₁, . . . , P₂₃ of the above transparent transformation matrix are obtained as three-dimensional measurement parameters for the cameras A, B, C, and are stored to the memory 23. When this registration is completed, three-dimensional measurement of the workpiece W is ready to be performed.

In the three-dimensional measurement processing of this embodiment, edges are extracted from the images generated by the cameras A, B, C. Thereafter the edges are divided into units called “segments” based on connection points and branching points, and the segments are associated with each other over the images. Then, for each of the combinations of segments associated with each other, the calculation using the above parameters is executed, so that a set of three-dimensional coordinates representing a three-dimensional segment can be derived. This processing will be hereinafter referred to as “reconstruction of three-dimensional information”.

In this embodiment, for the above reconstruction processing of three-dimensional information, a three-dimensional model M representing the entire outline shape of the workpiece W is generated as shown in FIG. 3. This three-dimensional model M includes three-dimensional information about a plurality of segments and a three-dimensional coordinate of one point O in the inside (such as barycenter) as a representative point.

In the recognition processing using the above three-dimensional model M, each feature point in the three-dimensional information reconstructed from the three-dimensional measurement (more specifically, branching point of segment) is associated with each feature point on the three-dimensional model M side in a round-robin manner, so that the degree of similarity between both of them is calculated. Then, an association between the feature points in which the degree of similarity is the largest is determined to be correct. At this occasion, a coordinate corresponding to the representative point O of the three-dimensional model M is recognized as the position of the workpiece W. When the three-dimensional model M is in this identified relationship, the rotational angle of the three-dimensional model M is recognized as the rotational angle of the workpiece W with respect to a basic posture represented by the three-dimensional model M. This rotational angle is calculated in each of axes X, Y, Z.

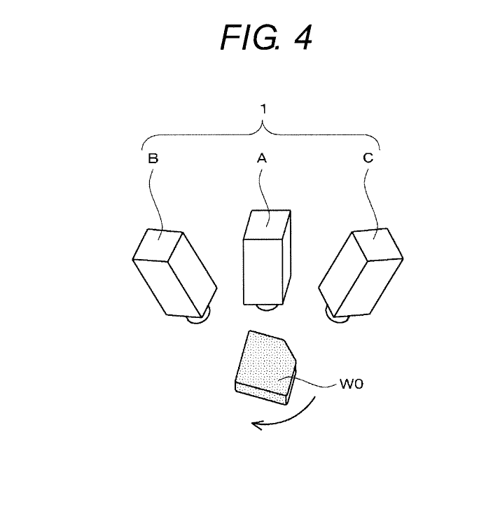

FIG. 4 shows a method for generating the above three-dimensional model M.

According to this embodiment, In the calibration processing, the height of the supporting surface of the workpiece W (the upper surface of the conveyance line 101 of FIG. 1) is set to be zero, and an actual model W0 of the workpiece W (hereinafter referred to as a “work model W0”) is arranged in a range on this supporting surface in which the visual fields of the camera A, B, C overlap. Then, this workpiece model W0 is rotated multiple times by any angle, so that the posture of the workpiece model W0 with respect to the cameras A, B, C is set in a plurality of ways. Every time the posture is set, imaging and the reconstructing processing of three-dimensional information are executed. Then, the plurality of pieces of reconstructed three-dimensional information are integrated to be a three-dimensional model M.

However, in this embodiment, the three-dimensional model M is not registered immediately after the integrating processing. Instead, experimental recognition processing is executed with this three-dimensional model M (hereinafter referred to as a “recognition test”), so as to confirm whether the workpiece W can be correctly recognized. This recognition test is executed by using the reconstructed three-dimensional information when the workpiece model W0 is measured in a posture different from that when the three-dimensional model is integrated. On the other hand, when the user determines that the result of this recognition test is bad, the three-dimensional information used in the recognition test is additionally registered to the three-dimensional model. As a result, the accuracy of the three-dimensional model can be improved, and the accuracy of the recognition processing on the actual workpiece W can be ensured.

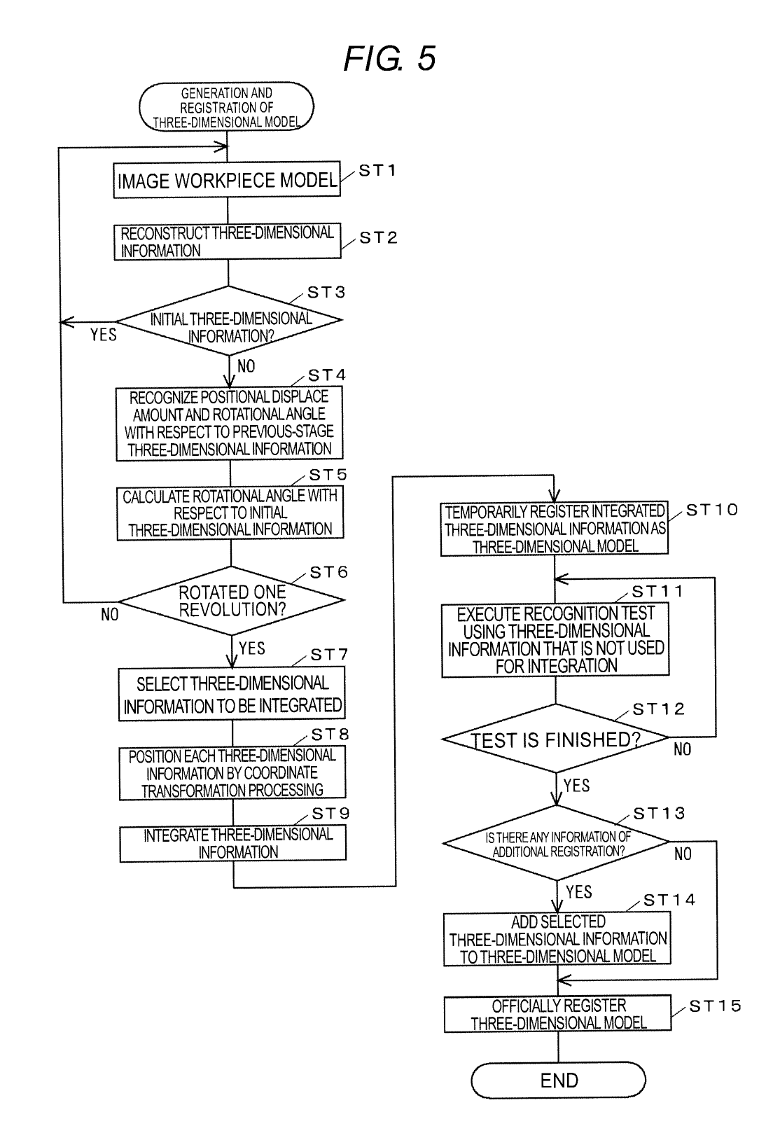

FIG. 5 shows a series of steps of three-dimensional model generation and registration processing.

In this embodiment, under the condition that the rotational direction is maintained in the same direction, the user rotates the workpiece model W0 by an appropriate angle, and performs imaging-instruction operation. The recognition processing apparatus 2 causes the cameras A, B, C to take images in accordance with this operation (ST1), and the generated images are used to reconstruct the three-dimensional information of the workpiece model W0 (ST2).

Further, in the second and subsequent processing (“NO” in ST3), the amount of positional shift and the rotational angle of the reconstructed three-dimensional information with respect to previous-stage three-dimensional information are recognized (ST4). This processing is also carried out in the same manner as the recognition processing of the three-dimensional model. That is, this processing is performed as follows: feature points in the three-dimensional information of both of them are associated with each other in a round-robin manner, so that the degree of similarity therebetween is calculated, and a relationship therebetween in which the degree of similarity is the largest is determined.

Further, the rotational angle is obtained by adding a recognized value on every rotation and calculating the rotational angle with respect to the three-dimensional information reconstructed first. Further, a determination is made, based on this rotational angle, as to whether the workpiece model W0 has rotated one revolution (ST5, ST6).

When the above rotational angle exceeds 360 degrees, and then a determination is made that the workpiece model W0 has rotated one revolution with respect to the stereo camera 1, the loop from ST1 to ST6 is terminated, and the process proceeds to ST7.

In ST7, a predetermined number of pieces of three-dimensional information are selected, automatically or according to the user's selection operation, from among the plurality of pieces of three-dimensional information reconstructed in the loop of ST1 to ST6.

Subsequently, in ST8, one of the selected pieces of three-dimensional information is set as reference information, and the remaining pieces of three-dimensional information are subjected to coordinate transformation processing based on the rotational angle and the positional displacement with respect to the reference information, so that the position and attitude are brought into conformity with the reference information (this will be hereinafter referred to as “positioning”) Thereafter, the three-dimensional information having been subjected to the positioning is integrated (ST9), and the integrated three-dimensional information is temporarily registered as a three-dimensional model (ST10).

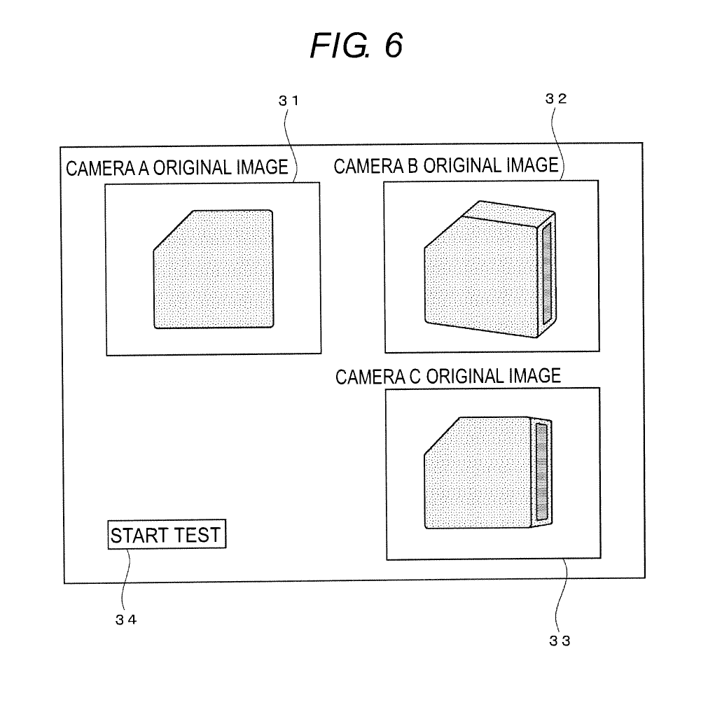

At this moment, three-dimensional information that was reconstructed in the loop of ST1 to ST6 but has not been integrated into any three-dimensional model are sequentially read, and their image information is also read. Then, recognition test is carried out as follows (ST11). FIG. 6 shows an example of screen displayed on the display device 25 when the recognition test starts. This screen is arranged with image display regions 31, 32, 33 for the cameras A, B, C, respectively, and the regions 31, 32, 33 on this screen shows images generated by imaging operations performed at predetermined times. On the lower side of the screen, a button 34 for instructing start of the recognition test is arranged.

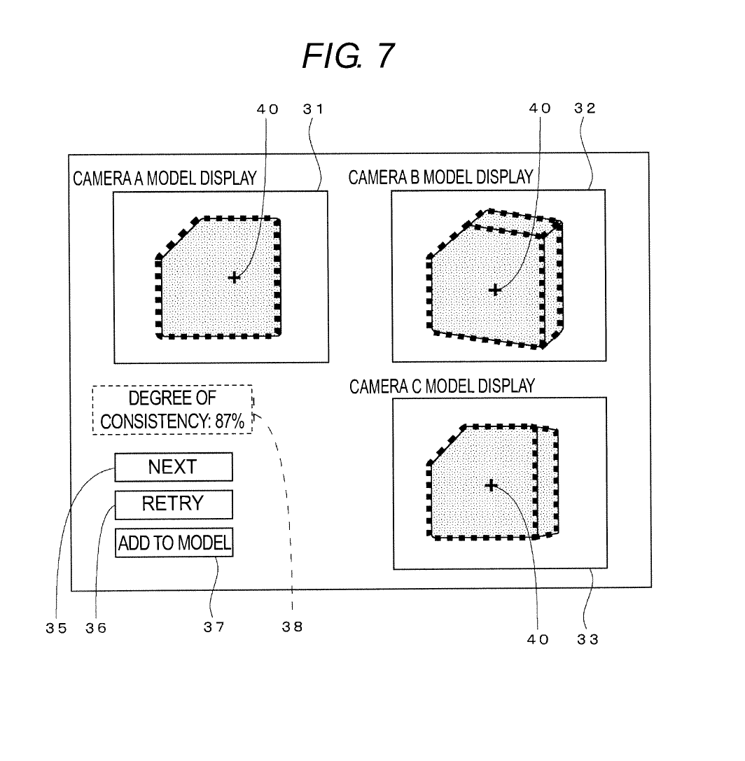

At this moment, when the user manipulates the button 34, a recognition test of the three-dimensional information corresponding to the displayed images is executed using a temporary three-dimensional model M. When the recognition test is finished, the display screen is switched to what is shown in FIG. 7.

In this screen, the same image as those prior to the test are displayed in the image display regions 31, 32, 33 of the cameras A, B, C. In this image, an outline (in the figure, the outline is indicated by a dashed line) in a predetermined color and a mark 40 indicating a recognized position are displayed in an overlaying manner.

The above outline and the mark 40 are generated by converting the coordinates of the temporary three-dimensional model M based on the rotational angle and the position obtained by the recognition test and projecting the three-dimensional coordinates of the converted three-dimensional model M onto the coordinate system of the camera A. More specifically, the calculation is executed using the below equation (2), which is derived from the above equation (1).

$$( \begin{matrix}x \\ y\end{matrix} ) = \frac{1}{{P}_{20} X + {P}_{31} Y + {P}_{22} Z + {P}_{23}} ( \begin{matrix}{P}_{00} & {P}_{01} & {P}_{02} & {P}_{03} \\ {P}_{10} & {P}_{11} & {P}_{12} & {P}_{13}\end{matrix} ) ( \begin{matrix}X \\ Y \\ Z \\ 1\end{matrix} ) \qquad ( 2 )$$

Further, this screen displays the degree of consistency of the three-dimensional information matched with the three-dimensional model M (indication in a dashed-lined box 38 in the figure). Further, below this indication, the screen displays a button 35 for selecting a subsequent image, a button 36 for instructing retry, and a button 37 for instructing addition to a model.

At this occasion, when the user decides that the displayed test result is preferable and manipulates the button 35, the screen of FIG. 6 is displayed again. Each of the image display regions 31, 32, 33 displays the image corresponding to the three-dimensional information that is to be subsequently tested, and the apparatus waits or user's operation. On the other hand, when the button 36 is manipulated, the currently selected image is used to execute the recognition test again, and the recognition result thereof is displayed.

When the user decides that the recognition accuracy is bad based on the displayed test result and manipulates the button 37, the three-dimensional information used in the recognition test is stored to be additionally registered. Thereafter, the processing is performed on the three-dimensional information that is to be subsequently tested.

The below process of the recognition test can be carried out according to the same process as described above (ST11, ST12). When a confirming test is finished, it is checked whether there is any information additionally registered (ST13). If there is any corresponding information, the three-dimensional information is subjected to the same coordinate transformation processing as that of ST8 and is positioned with the three-dimensional model M. The three-dimensional information subjected to the positioning processing is added to a three-dimensional model (ST14). Then, the additionally registered three-dimensional model M is officially registered (ST15), and the processing is terminated. When there is no information for additional registration (“NO” in ST13), namely, when the results of the recognition test are all good, the temporarily registered three-dimensional model is officially registered.

According to the above processing, the plurality of pieces of three-dimensional information obtained by measuring the workpiece model W0 from various directions are integrated, and the three-dimensional model M representing the entire structure of the workpiece W is generated. Thereafter, registration is performed after the degree of accuracy of the three-dimensional model is confirmed by the recognition test using the three-dimensional information including information that is not included in this three-dimensional model M. Therefore, it is possible to prevent registration of a three-dimensional model having poor accuracy. The accuracy of the three-dimensional model can be improved by adding, to the three-dimensional model M, the three-dimensional information of which recognition test result is bad.

As shown in FIG. 7, in this embodiment, the three-dimensional model M is subjected to coordinate transformation processing based on the recognition result, and is subjected to transparent transformation processing to be converted into the coordinate systems of the cameras A, B, C. The result of the transparent transformation processing is displayed in overlaying manner by overlaying on the image that is used in the recognition processing and is generated by the cameras A, B, C. Therefore, the user can easily determine the recognition accuracy from the outline shape of the three-dimensional model M and the degree of positional displacement with respect to the image of the workpiece model W0.

As described above, in the above embodiment, when the three-dimensional model M used for the recognition processing is generated, the screen as shown in FIG. 7 is displayed for the purpose of confirming the recognition accuracy thereof. However, the present invention is not limited thereto. Even when real recognition processing is executed after the three-dimensional model M is registered, the same screen may be displayed, so that the user can proceed with operation while confirming whether or not each of the recognition results is appropriate.

On the other hand, when registration is performed after the degree of accuracy of the three-dimensional model M is confirmed by the previous recognition test, the recognition result may be notified by displaying only the projected image of the model M without displaying the image of the actual workpiece W. In the above embodiment, after the recognition processing is finished, the three-dimensional model is subjected to coordinate transformation processing based on the recognition result and is then subjected to transparent transformation processing. However, in a case where the result of the coordinate transformation processing is stored when the feature points are associated with each other in a round-robin manner in the recognition processing, the stored data may be used to avoid repeatedly performing the coordinate transformation processing again.

What is claimed is:

1. A model display method to be executed by a three-dimensional optical sensor including a plurality of cameras for generating a stereo image, a recognizing unit, and a registering unit, wherein the recognizing unit executes three-dimensional measurement using the stereo image generated by imaging a predetermined recognition-target object with each of the cameras, matches three-dimensional information reproduced by the measurement with a three-dimensional model of the recognition-target object and recognizes a position and an attitude of the recognition-target object, and wherein the registering unit registers the three-dimensional model, the model display method comprising:
a first step for performing coordinate conversion of the three-dimensional model that has been or has not yet been registered to the registering unit based on the position and the attitude that have been recognized by the recognizing unit, and performing transparent transformation of the coordinate-converted three-dimensional model into a coordinate system of at least one of the plurality of cameras to thereby generate a projected image of the three-dimensional model; and
a second step for displaying, on a monitor apparatus, the projected image generated by the transparent transformation performed in the first step.

2. The model display method for a three-dimensional optical sensor according to claim 1, wherein the first step is executed with respect to all of the plurality of cameras, and wherein, in the second step, the projected image generated in the first step is displayed in overlaying manner by overlaying on the image that is generated by each of the cameras and used in the recognition processing performed by the recognizing unit.

3. A three-dimensional optical sensor including a plurality of cameras generating a stereo image, a recognizing unit, and a registering unit, wherein the recognizing unit executes three-dimensional measurement using the stereo image generated by imaging a predetermined recognition-target object with each of the cameras, and matches three-dimensional information reproduced by the measurement with a three-dimensional model of the recognition-target object and recognizes a position and an attitude of the recognition-target object, and wherein the registering unit registers the three-dimensional model, three-dimensional optical sensor comprising:
a transparent transformation unit for performing coordinate conversion of the three-dimensional model that has been or has not yet been registered to the registering unit based on the position and a rotational angle that have been recognized by the recognizing unit, and performing transparent transformation of the coordinate-converted three-dimensional model into a coordinate system of at least one of the plurality of cameras to thereby generate a projected image of the three-dimensional model; and
a display control unit for displaying, on a monitor apparatus, the projected image generated in the processing performed by the transparent transformation unit.

4. The three-dimensional optical sensor according to claim 3, wherein the transparent transformation unit executes the transparent transformation processing with respect to all of the plurality of cameras, and wherein the display control unit displays the projected image in overlaying manner by overlaying on the image that is generated by each of the cameras and used in the recognition processing performed by the recognizing unit.
